(19) United States
(12) Patent Application Publication
(10) Pub. No.: US 2026/0230363 A1
(43) Pub. Date: Aug. 6, 2026

(54) Preamble Extension for Transmission Parameter Estimation

(71) Applicant: Telefonaktiebolaget LM Ericsson (publ), Stockholm (SE)

(72) Inventors: Leif Wilhelmsson, Lund (SE); Dennis Sundman, Sollentuna (SE); Rocco Di Taranto, Lund (SE); Miguel Lopez, Aachen (DE)

(21) Appl. No.: 19/148,496

(22) PCT Filed: Jan. 19, 2023
(86) PCT No.: PCT/EP2023/051244

§ 371 Date: Jul. 16, 2025

(51) Int. Cl. H04L 27/26; H04W 84/12

(52) U.S. Cl. CPC H04L 27/2613; H04L 27/2605; H04W 84/12

(57) ABSTRACT

A wireless communication device (10, 20) receives at least one wireless transmission consisting of a preamble portion and a data portion. The preamble portion consists of an initial part, which is supported by a set of wireless communication devices (10, 20), and an extension part which is supported by only a subset of the set of wireless communication devices (10, 20). In response to the wireless communication device (10, 20) belonging to the subset, the wireless communication device (10, 20) estimates at least one transmission parameter based on the extension part of the received wireless transmission.

### TECHNICAL FIELD

The present invention relates to methods for controlling wireless transmissions and to corresponding devices, systems, and computer programs.

### BACKGROUND

Wireless communication technologies may use licensed frequency bands and/or license-exempt frequency bands. A typical example of a wireless communication technology operating in license-exempt frequency bands is the WLAN (Wireless Local Area Network) technology, according to “IEEE Standard for Information Technology—Telecommunications and Information Exchange between Systems-Local and Metropolitan Area Networks—Specific Requirements-Part 11: Wireless LAN Medium Access Control (MAC) and Physical Layer (PHY) Specifications,” in IEEE Std 802.11-2020 (Revision of IEEE Std 802.11-2016), pp. 1-4379, 26 Feb. 2021, in the following denoted as “IEEE 802.11 standard”. The WLAN technology based on the IEEE 802.11 Standard is also referred to as “Wi-Fi”.

In Wi-Fi systems, but also in other wireless communication technologies, there is a fundamental limit, with respect to what data rate can be supported at a given signal-to-noise-ratio (SNR) at the receiver, which can be attributed to the principles of Shannon's theorem. The limit is also referred to as the channel capacity, C. For an additive white Gaussian noise (AWGN) channel, the channel capacity is given by C=BW log(1+SNR), where BW is the bandwidth and SNR is the signal-to-noise-ratio. Typically, the channel capacity is measured in bits/s, and the “log” in the afore-mentioned expression would denote the binary logarithm.

Shannon's theorem thus defines a theoretical upper bound for performance of a wireless communication system. Currently existing systems are however capable of achieving practical performances which are close to this theoretical bound. Accordingly, the expression for the channel capacity may be used as a basis for understanding the behavior of the wireless communication system for a given SNR. Here, it is important to note that in this expression the SNR relates to energy per information bit. The signal power, P, can be expressed as P=Eb Rb, i.e., Eb=P/Rb, where Eb is the energy per information bit and Rb is the bit rate. Thus, if the received power P decreases due to an increase in the pathloss between the transmitter and the receiver, and Eb shall not decrease, Rb needs to decrease in proportion to P. As an example, if the wireless communication system needs to operate at a SNR that is reduced by 3 dB, the bit rate needs to be reduced by a factor of two. The reduction of the bit rate can for example be achieved by adding redundancy, e.g., by repeatedly sending the same symbols and accumulating the received energy over the repeated symbols at the receiver. When doing so, the accumulation of the energy corresponding to the same repeated symbols needs to be coherent.

Critical elements in the receiver processing are time and frequency estimation. Before the actual data can be efficiently demodulated based on the above-mentioned coherent accumulation, it is necessary to obtain time synchronization, estimate frequency offset, and also estimate phase of the received signals. In addition, the wireless channel between the transmitter and the receiver may need to be estimated to enable signal equalization at the receiver. Such kind of estimation is herein also denoted as parameter estimation and may be accomplished based on a known set of symbols sent by the transmitter, which may be included in a preamble of the wireless transmission. The receiver may then perform the parameter estimation based on the known symbols as received from the transmitter.

A recent amendment to the IEEE 802.11 standard, “IEEE Standard for Information Technology—Telecommunications and Information Exchange between Systems Local and Metropolitan Area Networks—Specific Requirements Part 11: Wireless LAN Medium Access Control (MAC) and Physical Layer (PHY) Specifications Amendment 1: Enhancements for High-Efficiency WLAN”, in the following denoted as “802.11ax amendment”, has introduced a high efficiency (HE) extended range (ER) single user physical layer (PHY) protocol data unit (PPDU). In such HE ER SU PPDU, elements of the preamble, denoted as L-STF (Legacy Short Training Field), L-LTF (Legacy Long Training Field), and L-SIG (Legacy Signal), are boosted by 3 dB with respect to ordinary PPDUs. These preamble elements are part of a “legacy preamble” which is decodable by all STAs complying with the IEEE 802.11 standard. Further, the preamble of the HE ER SU PPDU includes an element denoted as HE-SIG-A (HE Signal A), which is twice as long as a regular HE-SIG-A, due to a repetition of HE-SIG-A, with the signals of the repetition being phase rotated by 90° with respect to the initial HE-SIG-A. This may be regarded as an extended HE-SIG-A sequence. STAs which support the 802.11ax amendment can detect the extended HE-SIG-A sequence based on the 90°phase rotation of the repetition.

The IEEE 802.11 standard also includes, through the 802.11ah amendment (see “IEEE Standard for Information technology—Telecommunications and information exchange between systems-Local and metropolitan area networks—Specific requirements-Part 11: Wireless LAN Medium Access Control (MAC) and Physical Layer (PHY) Specifications Amendment 2: Sub 1 GHz License Exempt Operation”), features for long range communication in the sub 1 GHz band, which are based on a PHY mode called S1G_1M, to be used with 1 MHz bandwidth. As compared to regular PHY mode denoted as S 1G_SHORT and used with 2 MHz, 4 MHz, 8 MHz or 16 MHz bandwidth, the L-STF and L-LTF are repeated twice and the L-SIG is repeated three times.

When attempting to increase the range of wireless transmissions by reducing the data rate it may also be required to use a longer sequence of preamble symbols for parameter estimation. However, such longer sequence will also increase signal overhead. Further, when operating in a license-exempt frequency band, the symbols of the preamble are not only used for parameter estimation, but also for detecting whether there is an ongoing wireless transmission by other devices. For example, in the IEEE 802.11 standard the legacy preamble is used by other devices for performing carrier sense multiple access with collision avoidance (CSMA/CA). Modifying the symbol sequence of the legacy preamble may thus impact coexistence with legacy STAs.

Accordingly, there is a need for techniques which allow for efficiently performing parameter estimation for wireless transmissions.

### SUMMARY

According to an embodiment, a method of controlling wireless transmissions in a wireless communication system is provided. According to the method, a wireless communication device receives at least one wireless transmission consisting of a preamble portion and a data portion. The preamble portion consists of an initial part, which is supported by a set of wireless communication devices, and an extension part which is supported by only a subset of the set of wireless communication devices. In response to the wireless communication device belonging to the subset, the wireless communication device estimates at least one transmission parameter based on the extension part of the received wireless transmission.

According to a further embodiment, a method of controlling wireless transmissions in a wireless communication system is provided. According to the method, a wireless communication device sends at least one wireless transmission consisting of a preamble portion and a data portion. The preamble portion consists of an initial part, which is supported by a set of wireless communication devices, and an extension part which is supported by only a subset of the set of wireless communication devices. The initial part enables estimation of at least one transmission parameter by the set of wireless communication devices and the extension part enables enhanced estimation of the at least one transmission parameter by the subset of the set of wireless communication devices.

According to a further embodiment, a wireless communication device for a wireless communication system is provided. The wireless communication device is configured to receive at least one wireless transmission consisting of a preamble portion and a data portion. The preamble portion consists of an initial part, which is supported by a set of wireless communication devices, and an extension part which is supported by only a subset of the set of wireless communication devices. Further, the wireless communication device is configured to, in response to the wireless communication device belonging to the subset, estimate at least one transmission parameter based on the extension part of the received wireless transmission.

According to a further embodiment, a wireless communication device for a wireless communication system is provided. The wireless communication device comprises at least one processor and a memory. The memory contains instructions executable by said at least one processor, whereby the wireless communication device is operative to receive at least one wireless transmission consisting of a preamble portion and a data portion. The preamble portion consists of an initial part, which is supported by a set of wireless communication devices, and an extension part which is supported by only a subset of the set of wireless communication devices. Further, the memory contains instructions executable by said at least one processor, whereby the wireless communication device is operative to, in response to the wireless communication device belonging to the subset, estimate at least one transmission parameter based on the extension part of the received wireless transmission.

According to a further embodiment, a wireless communication device for a wireless communication system is provided. The wireless communication device is configured to send at least one wireless transmission consisting of a preamble portion and a data portion. The preamble portion consists of an initial part, which is supported by a set of wireless communication devices, and an extension part which is supported by only a subset of the set of wireless communication devices. The initial part enables estimation of at least one transmission parameter by the set of wireless communication devices and the extension part enables enhanced estimation of the at least one transmission parameter by the subset of the set of wireless communication devices.

According to a further embodiment, a wireless communication device for a wireless communication system is provided. The wireless communication device comprises at least one processor and a memory. The memory contains instructions executable by said at least one processor, whereby the wireless communication device is operative to send at least one wireless transmission consisting of a preamble portion and a data portion. The preamble portion consists of an initial part, which is supported by a set of wireless communication devices, and an extension part which is supported by only a subset of the set of wireless communication devices. The initial part enables estimation of at least one transmission parameter by the set of wireless communication devices and the extension part enables enhanced estimation of the at least one transmission parameter by the subset of the set of wireless communication devices.

According to a further embodiment, a computer program or computer program product is provided, e.g., in the form of a non-transitory storage medium, which comprises program code to be executed by at least one processor of a wireless communication device for a wireless communication system. Execution of the program code causes the wireless communication device to receive at least one wireless transmission consisting of a preamble portion and a data portion. The preamble portion consists of an initial part, which is supported by a set of wireless communication devices, and an extension part which is supported by only a subset of the set of wireless communication devices. Further, execution of the program code causes the wireless communication device to, in response to the wireless communication device belonging to the subset, estimate at least one transmission parameter based on the extension part of the received wireless transmission.

According to a further embodiment, a computer program or computer program product is provided, e.g., in the form of a non-transitory storage medium, which comprises program code to be executed by at least one processor of a wireless communication device for a wireless communication system. Execution of the program code causes the wireless communication device to send at least one wireless transmission consisting of a preamble portion and a data portion. The preamble portion consists of an initial part, which is supported by a set of wireless communication devices, and an extension part which is supported by only a subset of the set of wireless communication devices. The initial part enables estimation of at least one transmission parameter by the set of wireless communication devices and the extension part enables enhanced estimation of the at least one transmission parameter by the subset of the set of wireless communication devices.

Details of such embodiments and further embodiments will be apparent from the following detailed description.

### BRIEF DESCRIPTION OF THE DRAWINGS

FIG. 1 schematically illustrates a wireless communication system according to an embodiment.

FIG. 2 schematically illustrates an example of a wireless transmission consisting of a preamble portion and a data portion as used in embodiments of the present disclosure.

FIG. 3 schematically illustrates estimation of a transmission parameter based on autocorrelation of a received signal.

FIGS. 4A and 4B schematically illustrate a wireless transmission including an extended preamble in accordance with an embodiment of the present disclosure.

FIG. 5 schematically illustrates a sequence of wireless transmissions in accordance with an embodiment of the present disclosure.

FIG. 6 schematically illustrates estimation of a transmission parameter based on multi-delay autocorrelation of a received signal.

FIG. 7 shows a flowchart for schematically illustrating a method according to an embodiment of the present disclosure.

FIG. 8 shows a flowchart for schematically illustrating a further method according to an embodiment of the present disclosure.

FIG. 9 schematically illustrates structures of a wireless communication device according to an embodiment of the present disclosure.

### DETAILED DESCRIPTION

In the following, concepts in accordance with exemplary embodiments of the invention will be explained in more detail and with reference to the accompanying drawings. The illustrated embodiments relate to controlling of wireless transmissions in a wireless communication system. The wireless communication system may be a WLAN system based on IEEE 802.11 technology. However, it is noted that the illustrated concepts could also be applied to other wireless communication technologies, e.g., to contention-based modes of the LTE (Long Term Evolution) or NR (New Radio) technology specified by 3GPP (3^{rd} Generation Partnership Project) or to the Bluetooth technology.

In the illustrated concepts, a preamble portion of wireless transmission is extended, e.g., with the aim of improving estimation of transmission parameters in scenarios where the coverage range is extended by lowering the data rate. Specifically, for at least some wireless transmissions, the preamble portion includes, in addition to an initial part, an extension part. The initial part is supported by a set of wireless communication devices, e.g., all wireless devices which are compliant with a certain standard. The extension part is supported by a subset of the set of wireless communication devices, e.g., a subset which supports a certain enhancement of the standard. In the examples as further illustrated herein, the set of wireless communication devices may correspond to all STAs complying with the IEEE 802.11 standard, including legacy STAs which support only legacy features of the IEEE 802.11 standard. Such STAs are herein also denoted as legacy STAs. The subset of the wireless communication devices may in turn correspond to STAs which support a certain enhancement of the IEEE 802.11 standard, e.g., a mode for long range transmissions. The initial part of the preamble portion may correspond to the legacy preamble of the IEEE 802.11 standard, including the L-STF, L-LTF, and L-SIG. The extension part may be an extension of the legacy preamble which enables or enhances estimation of transmission parameters like reference time and/or frequency error in the mode for long range transmissions. In some scenarios, the extension part of the preamble portion may be included in only some of the wireless transmissions of a sequence of wireless transmission, e.g., in the first wireless transmission and/or in every j-th wireless transmission, with j being an integer larger than one. In this way, excessive overhead due to the extended preamble portion can be avoided.

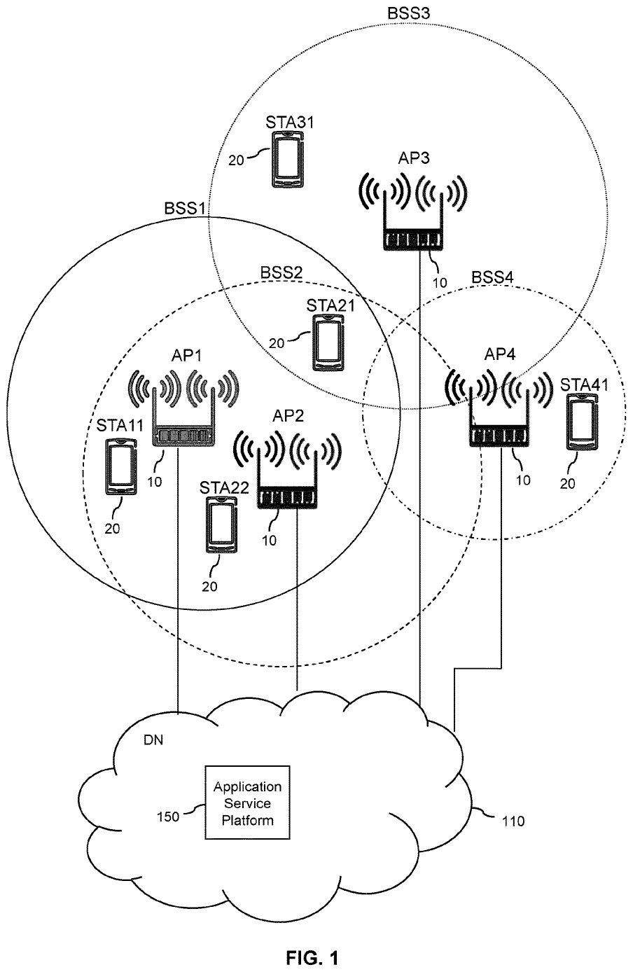

FIG. 1 illustrates an exemplary wireless communication system according to an embodiment. In the illustrated example, the wireless communication system includes multiple APs 10, in the illustrated example referred to as AP1, AP2, AP3, AP4, and multiple stations 20, in the illustrated example referred to as STA11, STA21, STA22, STA31, and STA41. STA11 is served by AP1, in a first BSS (Basic Service Set) denoted as BSS1. STA21 and STA22 are served by AP2, in a second BSS denoted as BSS2. STA31 is served by AP3, in a third BSS denoted as BSS3. STA41 is served by AP4, in a fourth BSS denoted as BSS4. The stations 20 may be non-AP STAs and correspond to various kinds of wireless devices, for example user terminals, such as mobile or stationary computing devices like smartphones, laptop computers, desktop computers, tablet computers, gaming devices, or the like. Further, the stations 20 could for example correspond to other kinds of equipment like smart home devices, printers, multimedia devices, data storage devices, or the like.

In the example of FIG. 1, each of the stations 20 may connect through a radio link to one of the APs 10. For example, depending on location or channel conditions experienced by a given station 20, the station 20 may select an appropriate AP 10 and BSS for establishing the radio link. The radio link may be based on one or more OFDM carriers from a frequency spectrum which is shared on the basis of a contention-based mechanism, e.g., an unlicensed or license-exempt band like the 2.4 GHz ISM (Industrial, Scientific and Medical) band, the 5 GHz band, the 6 GHz band, or the 60 GHz band.

Each AP 10 may provide data connectivity of the stations 20 connected to the AP 10. As further illustrated, the APs 10 may be connected to a data network (DN) 110. In this way, the APs 10 may also provide data connectivity between stations 20 connected to different APs 10. Further, the APs 10 may also provide data connectivity of the stations 20 to other entities, e.g., to one or more servers, service providers, data sources, data sinks, user terminals, or the like. Accordingly, the radio link established between a given station 20 and its serving AP 10 may be used for providing various kinds of services to the station 20, e.g., a voice service, a multimedia service, or other data service. Such services may be based on applications which are executed on the station 20 and/or on a device linked to the station 20. By way of example, FIG. 1 illustrates an application service platform 150 provided in the DN 110. The application(s) executed on the station 20 and/or on one or more other devices linked to the station 20 may use the radio link for data communication with one or more other stations 20 and/or the application service platform 150, thereby enabling utilization of the corresponding service(s) at the station 20.

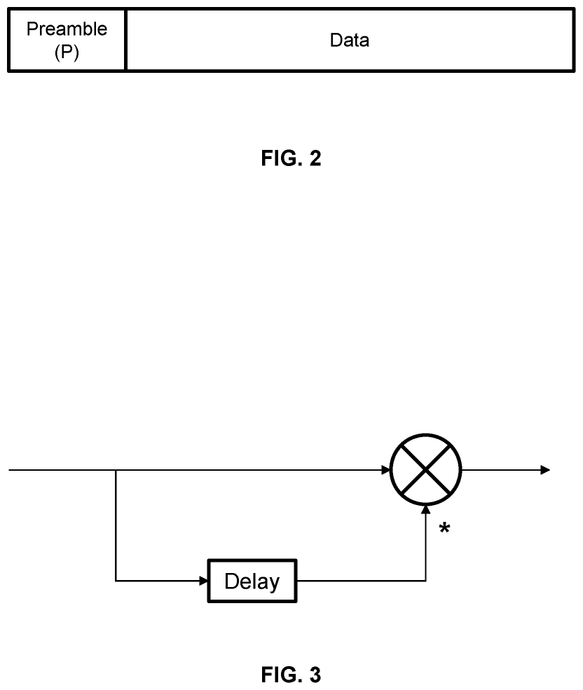

For at least some of the radio links between the APs 10 and STAs 20, a mode for long range transmissions may be utilized, which in the following will also be denoted as “long-range (LR) mode”. As compared to regular transmission modes, the LR mode offers an increased transmission range in which wireless transmissions can be successfully received. The LR mode may be based on reducing the data rate as compared to the regular transmission modes. Each wireless transmission sent in the LR mode includes a preamble portion and a data portion. FIG. 2 schematically illustrates a corresponding data structure. The data structure of FIG. 2 may for example correspond to a PPDU. The preamble portion has the purpose of enabling estimation of one or more transmission parameters, e.g., reference time and/or frequency offset. In some scenarios, the preamble portion may include multiple fields, with a first field being intended for coarse time and frequency estimation and a second field being intended for channel estimation and optionally refined frequency estimation. Examples of such fields are the L-STF and the L-LTF of the IEEE 802.11 technology. In some scenarios, the preamble portion may also be used for obtaining a phase reference, e.g., to be used for coherent combining of repetitive data signals. The LR mode may be used either in downlink (DL) direction, with an AP 10 as transmitter and an associated station 20 acting as receiver, in uplink (UL) direction, with an AP 10 acting as receiver and an associated station 20 acting as transmitter, or in bidirectional communication in both the DL direction and the UL direction. It is however noted that it would also be possible to utilize the LR mode for direct wireless transmissions between two stations 20.

In the IEEE 802.11 technology, a variety of modulation and coding schemes (MCSs) can be used for transmitting the data. The most robust MCS, denoted as “MCS0” uses binary phase shift keying (BPSK) and a code rate of 1/2. When used in connection with low density parity check (LDPC) encoding, MCSO can operate at an SNR of around 0 dB. In such configuration, the estimation of transmission parameters based on the legacy preamble of the IEEE 802.11 technology can become a limiting factor for the achievable data transmission performance on the radio link. In the claimed solution, estimation of the transmission parameter(s) can be enhanced by the extended preamble portion, which includes more known symbols and/or fields that can be used by the subset of the STAs in the LR mode for performing the estimation. Further, since the preamble portion still includes the initial part, it is also usable by legacy STAs for performing the estimation. The enhanced estimation of the transmission parameter(s) may enable operation of the radio link at lower SNR than possible when using only the legacy preamble.

In some implementations, the estimation of the transmission parameter(s) by the STAs in the LR mode can be further improved by basing the estimation on cross-correlation instead of autocorrelation.

In the case of autocorrelation, the received signal is correlated with a delayed version of itself: FIG. 3 schematically illustrates a corresponding signal processing architecture. When such autocorrelation is done at low SNR, e.g., with the noise power being about the same level as the signal power, the output of the autocorrelation will include a noise contribution which is proportional to the square of the noise power. Performing the autocorrelation-based estimation at SNRs of 0 dB or less is thus quite challenging. On the other hand, the autocorrelation-based estimation is capable of handling rather large frequency offsets. The amount of frequency offset that can be handled is determined by the amount of delay D that is used in the autocorrelation. From FIG. 3, it can be seen that, if the received signal has a frequency offset f_{off}, the phase of the autocorrelation output will be φ=2π·f_{off}·D. The phase φ of the autocorrelation output can thus be used to estimate the frequency offset, provided that there is no ambiguity. Since the ambiguity is caused by phase folding, the phase φ should be in the range-π<100 ≤π, or equivalently the maximum value for the delay D that can be used is π/(2π·f_{off})=1/(2·f_{off}).

When considering the accuracy of the frequency offset estimate f_{off}, it is typically accurate to assume that the variance of the phase estimate φ can be considered as being independent of the delay D. Using this assumption and realizing that the frequency offset estimate is obtained by dividing the phase estimate φ by the delay D, it can be seen that the variance of the frequency offset estimate f_{off} is proportional to 1/D². Thus, by selecting a large value of the delay D, it is possible to improve the frequency offset estimate f_{off}. Accordingly, an increased delay D may be beneficial in situations where uncertainty concerning the frequency offset f_{off} is not too high.

Combining this result with the above requirement on the maximum value for the delay D, it follows that a more accurate estimate of the frequency offset f_{off} can be achieved by reducing the maximum possible frequency offset f_{off}. Further, by increasing the delay D, a less accurate phase estimate φ still allows for obtaining a frequency offset estimate f_{off} with sufficient accuracy.

In the case of cross-correlation, the received signal is correlated with a pre-defined sequence in the receiver. When the received signal is the same as the pre-defined sequence, the cross-correlation output will show a distinct peak. Cross-correlation may thus provide a significantly better performance than autocorrelation, which can be attributed to the pre-defined sequence being noise free. When using cross-correlation, the phase of the received signal may need to be relatively constant. As a rule-of-thumb, the phase φ should not change more than 2π/3 while performing the cross-correlation. Accordingly, the cross-correlation may be applied in situations where uncertainty concerning the phase φ is not too high.

Following the discussion above, it can be seen that the parameter estimation procedure can be conceptually separated in two tasks: 1) handling a large frequency offset, and 2) having a better accuracy of the frequency estimate. In the illustrated concepts, hese two tasks may be performed at least in part separately.

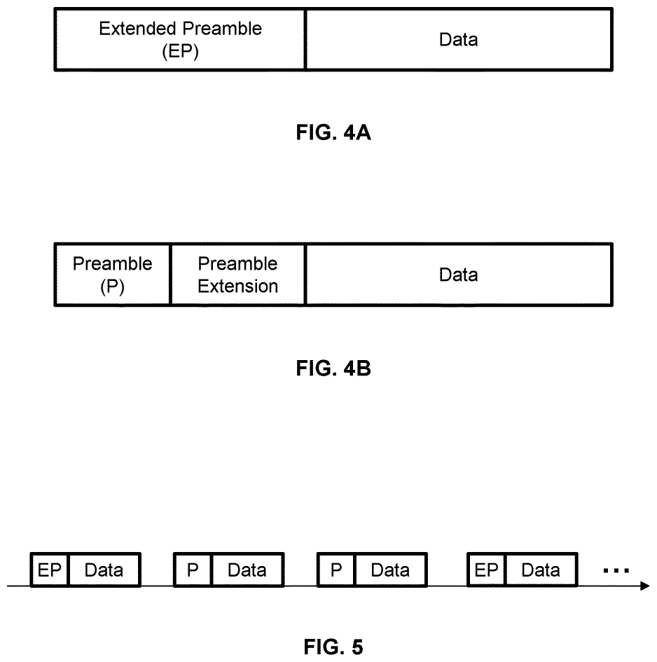

In the illustrated concepts, an extended preamble (EP), which allows for enhanced estimation of the transmission parameter(s) may be implemented by extending a legacy preamble with a preamble extension. The extended preamble thus consists of two parts, namely the legacy preamble and a preamble extension as illustrated in FIGS. 4A and 4B. In the illustration of FIGS. 4A and 4B, the legacy preamble is sent immediately before the preamble extension. It is however noted that other arrangements could be used as well.

When using a preamble extension as described above, the preamble extension may be intended to be used in combination with the legacy preamble. In such case, the receiver would perform the estimation of the transmission parameter(s) based on the entire extended preamble, i.e., based on both the legacy preamble and the preamble extension. In such cases, the preamble extension could for example correspond to a repetition of the legacy preamble. Alternatively, the preamble extension could be used in a stand-alone manner, i.e., the receiver would perform the estimation of the transmission parameter(s) based on only the preamble extension, without considering the legacy preamble. The legacy preamble may then still be used by other devices than the intended receiver of the packet for detecting that there is an ongoing transmission. Such other devices may include legacy devices which are not capable of decoding the preamble extension and may react by terminating reception processing of the PPDU upon detecting the preamble extension.

In situations where a large amount of data is to be transmitted, this typically involves transmission of a sequence of wireless transmissions, e.g., a sequence of PPDUs. The frequency offset at the receiver will typically be similar for all these wireless transmissions. Specifically, it can be expected that the difference in frequency offset between two wireless transmissions is significantly smaller than the frequency offset observed for an individual wireless transmission. Thus, once the receiver has estimated the frequency offset for one received wireless transmission, e.g., the first wireless transmission of the sequence, this estimate can be expected to be a quite good estimate also for the next wireless transmission(s) of the sequence. In the illustrated concepts, this may be exploited by using wireless transmissions with different preamble portions.

Specifically, the transmitter may send data to the receiver using PPDUs with at least two different preamble types: a first preamble is designed for operating with a first parameter uncertainty, and a second preamble for operating with a second parameter uncertainty that is smaller than the first parameter uncertainty. The first parameter and second parameter uncertainty refer to the uncertainty of the transmission parameter being estimated, which could be the frequency offset or reference time. The first preamble may be designed for performing the estimation in case of large parameter uncertainty, at the expense of possibly less accuracy of the obtained estimate. As compared to that, the second preamble may be designed for performing the estimation in case of smaller parameter uncertainty but offering a higher estimation accuracy. The first preamble may for example be used in the first PPDU of a sequence of PPDUs, and the second preamble may be used in one or more subsequent PPDUs. For accommodating the larger parameter uncertainty, the first preamble may have a longer duration than the second preamble, such as explained above for the extended preamble. Specifically, the first preamble may correspond to the above-mentioned extended preamble (or the extension part), and the second preamble may correspond to the legacy preamble, without the extension part. In some scenarios, the first preamble may be used only in the very first PPDU of the sequence, with the remaining PPDUs of the sequence using the second preamble. In other scenarios, the first preamble can be used in a repetitive pattern, e.g., in every j-th PPDU, with j being an integer ≥2. FIG. 5 illustrates an example of such scenario, in which the extended preamble is provided in the first PPDU and in every third subsequent PPDU. It is noted that in some scenarios the receiver may at least roughly know the expected arrival times of the PPDUs, e.g., in situations where the PPDUs convey periodic data traffic. The illustrated concepts may however also be applied in situations with irregular timing of the PPDUs.

In some scenarios, processing at the receiver may be adapted to the different preambles utilized. Specifically, when performing the estimation of parameters for a sequence of PPDUs, e.g., as described above, the receiver may apply a first algorithm for performing the estimation on one or more of the PPDUs, e.g., for the very first PPDU of the sequence or for every j-th PPDU, with j being an integer ≥2. The PPDUs on which the first algorithm is applied may correspond to the above-mentioned PPDUs having the first preamble designed for operating with the larger first parameter uncertainty, e.g., an extended preamble as for example illustrated in FIGS. 4A and 4B. On the other PPDUs the receiver may apply a second algorithm for performing the estimation. In some scenarios, both the first algorithm and the second algorithm may be based on autocorrelation of the received signal, however using different values of the delay D. Specifically, for the first algorithm the value of the delay D may be shorter than for the second algorithm. In other scenarios, the first algorithm may be based on autocorrelation, while the second algorithm is based on cross-correlation. In yet other scenarios, the first algorithm and the second algorithm are based on cross-correlation. For example, when using cross-correlation on a preamble sequence of length NM, this preamble sequence can be split in M sequences of length N. Each sequence of length N can then be processed using cross-correlation, and the M results from the cross-correlations can then be combined the M values in a non-coherent manner. N=1. And M=1 can be considered as extreme cases.

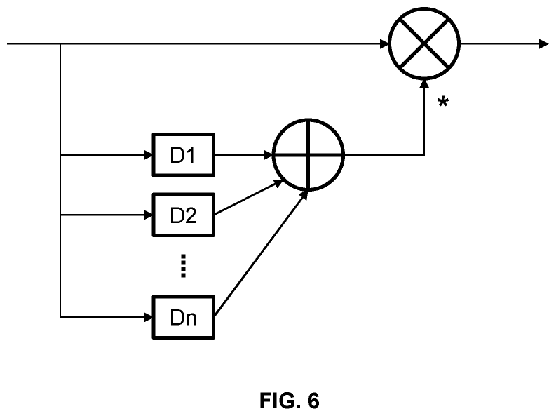

In some scenarios, the autocorrelation may be based on multiple different delays. FIG. 6 schematically illustrates a corresponding signal processing architecture. In the architecture of FIG. 6, the received signal is subjected to multiple different delays D1, D2, . . . Dn, with n being an integer ≥2 denoting the number of different delays. The differently delayed versions of the received signal are then summed and the sum of the delayed signals is correlated with the original received signal. If for example the estimation is performed on an L-STF and an extended STF (E-STF), which has a different repetition periodicity, the L-STF could be subjected to delay D1 and the E-STF could be subjected to a different delay D2.

In some scenario, the above-described concepts may be applied in an adaptive manner: In some cases, the extended preamble may be selected based on specific needs. For example, if the channel conditions are challenging, e.g., in the presence of interference or otherwise low SNR, the extended preamble may be further extended as compared to situations with less challenging channel conditions. Such further extension may for example be achieved by adding a repetition of the legacy preamble. Further, also the rate of sending the extended preamble may be adapted depending on the channel conditions. For example, if in a sequence of PPDUs every j-th PPDU is sent with the extended preamble, the value of j could be adapted depending on the channel conditions, e.g., by selecting a lower value of j when the channel conditions become more challenging. When performing such channel-condition dependent adaptation, the channel conditions may for example be considered based on feedback information from the intended receiver. The feedback information may for example include or reflect a measurement of SNR by the receiver, performed on an earlier PPDU, and/or information on the expected uncertainty of the transmission parameter(s) to be estimated. The adaptation may be based on comparing a value reflecting the channel conditions to one or more thresholds.

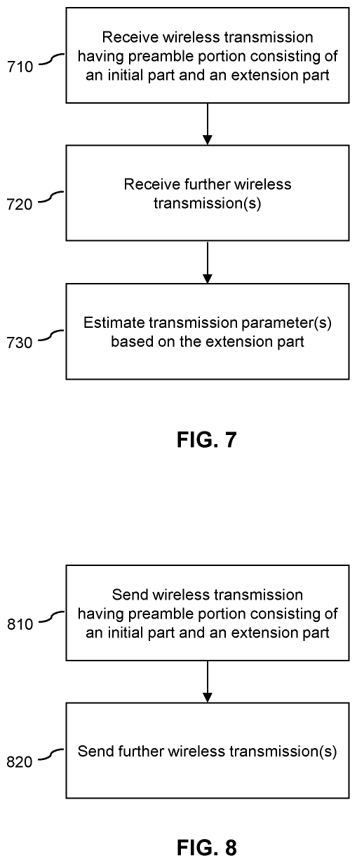

FIG. 7 shows a flowchart for illustrating a method of controlling wireless transmissions in a wireless communication system, which may be utilized for implementing the illustrated concepts. The method of FIG. 7 may be used for implementing the illustrated concepts in a wireless communication device operating in a wireless communication system, e.g., in an AP of the wireless communication system, e.g., one of the above-mentioned APs 10, or in a STA, such as one of the above-mentioned stations 20. The wireless communication system may be based on a wireless local area network, WLAN, technology, e.g., according to the IEEE 802.11 standards family.

If a processor-based implementation of the wireless communication device is used, at least some of the steps of the method of FIG. 7 may be performed and/or controlled by one or more processors of the wireless communication device. Such wireless communication device may also include a memory storing program code for implementing at least some of the below described functionalities or steps of the method of FIG. 7.

At step 710, the wireless communication device receives at least one wireless transmission. The at least one wireless transmission consists of a preamble portion and a data portion. The preamble portion consists of an initial part and an extension part, e.g., as illustrated for the extended preamble of FIGS. 4A and 4B. The initial part is supported by a set of wireless communication devices, e.g., all wireless communication devices complying with a certain standard, such as the IEEE 802.11 standard. The extension part which is supported by only a subset of the set of wireless communication devices, e.g., wireless communication devices that support an enhancement of the standard. The enhancement may be based on one or more standardized non-mandatory features and/or on proprietary features outside the standard. The enhancement may for example implement a transmission mode with extended range, such as the above-mentioned LR mode. The subset may then correspond to the wireless communication devices operating in the transmission mode with extended range. In some scenarios, the initial part of the preamble portion may correspond to the legacy preamble of the IEEE 802.11 standard. The extension part may be based on one or more repetitions of the legacy preamble. The at least one wireless transmission may for example correspond to a PPDU.

At step 720, the wireless communication device may receive one or more further wireless transmissions. More specifically, the wireless communication device receives a sequence of wireless transmissions. The sequence may include the at least one wireless transmission having the preamble portion with the extension part, as received at step 710, and at least one further wireless transmission having a preamble portion without the extension part. In such received sequence, only the first wireless transmission could have the preamble portion with the extension part or only every j-th wireless transmission could have the preamble portion with the extension part, where j is an integer larger than 1.

At step 730, in response to the wireless communication device belonging to the subset, the wireless communication device estimates at least one transmission parameter based on the extension part of the received wireless transmission. The at least one transmission parameter may include a frequency offset and/or a reference time. In some cases, the wireless communication device may estimate the at least one transmission parameter based on both the initial part and the extension part of the received wireless transmission. Alternatively, the wireless communication device could estimate the at least one transmission parameter based on only the extension part of the received wireless transmission. In response to the wireless communication device not belonging to the subset, the wireless communication device may terminate reception processing of the wireless transmission upon detecting the extension part.

If the wireless communication device receives a sequence of wireless transmissions as explained in connection with step 720, the wireless communication device may perform the estimation of the at least one transmission parameter with different estimation ranges for different wireless transmissions of the sequence. For the at least one wireless transmission having the preamble portion with the extension part, the wireless communication device may perform the estimation of the at least one transmission parameter within a first estimation range. For the at least one further wireless transmission having the preamble portion without the extension part, the wireless communication device may perform the estimation of the at least one transmission parameter within a second estimation range which is smaller than the first estimation range. The larger first estimation range may allow for considering higher expected uncertainty of the estimate.

The estimation of the at least one transmission parameter may be based on cross-correlation of at least the extension part with a predefined signal sequence. Alternatively or in addition, the estimation of the at least one transmission parameter is based on autocorrelation of at least the extension part with a predefined signal sequence.

FIG. 8 shows a flowchart for illustrating a method of controlling wireless transmissions in a wireless communication system, which may be utilized for implementing the illustrated concepts. The method of FIG. 8 may be used for implementing the illustrated concepts in a wireless communication device operating in a wireless communication system, e.g., in an AP of the wireless communication system, e.g., one of the above-mentioned APs 10, or in a STA 20, such as one of the above-mentioned STAs. The wireless communication system may be based on a wireless local area network, WLAN, technology, e.g., according to the IEEE 802.11 standards family.

If a processor-based implementation of the wireless communication device is used, at least some of the steps of the method of FIG. 8 may be performed and/or controlled by one or more processors of the wireless communication device. Such wireless communication device may also include a memory storing program code for implementing at least some of the below described functionalities or steps of the method of FIG. 8.

At step 810, the wireless communication device sends at least one wireless transmission. The at least one wireless transmission consists of a preamble portion and a data portion. The preamble portion consists of an initial part and an extension part, e.g., as illustrated for the extended preamble of FIGS. 4A and 4B. The initial part is supported by a set of wireless communication devices, e.g., all wireless communication devices complying with a certain standard, such as the IEEE 802.11 standard. The extension part is supported by only a subset of the set of wireless communication devices, e.g., wireless communication devices that support an enhancement of the standard. The enhancement may be based on one or more standardized non-mandatory features and/or on proprietary features outside the standard. The enhancement may for example implement a transmission mode with extended range, such as the above-mentioned LR mode. The subset may then correspond to the wireless communication devices operating in the transmission mode with extended range. The initial part enables estimation of at least one transmission parameter by the set of wireless communication devices and the extension part enables enhanced estimation of the at least one transmission parameter by the subset of the set of wireless communication devices. The wireless communication device may generate the extension part based on a repetition of at least a part of the initial part. For example, if the initial part includes or corresponds to a legacy preamble, the extension part could include a repetition of a least a part of the legacy preamble, e.g., one or more repetitions of an L-STF. The at least one transmission parameter may include a frequency offset and/or a reference time. In some scenarios, the initial part of the preamble portion may correspond to the legacy preamble of the IEEE 802.11 standard. The extension part may be based on one or more repetitions of the legacy preamble. The at least one wireless transmission may for example correspond to a PPDU.

In some scenarios, the wireless communication device may provide the extension part in a selective manner, depending on channel conditions, e.g., expected SNR or expected uncertainty of the transmission parameter(s) to be estimated. For example, the wireless communication device may include the extension part in response to the SNR being below a threshold or the uncertainty being above a threshold. Otherwise, the wireless communication device may omit the extension part.

At step 820, the wireless communication device may send one or more further wireless transmissions. More specifically, the wireless communication device may send a sequence of wireless transmissions. The sequence may include the at least one wireless transmission having the preamble portion with the extension part, as sent at step 810, and at least one further wireless transmission having a preamble portion without the extension part. In such sequence, only the first wireless transmission could have the preamble portion with the extension part or only every j-th wireless transmission could have the preamble portion with the extension part, where j is an integer larger than 1.

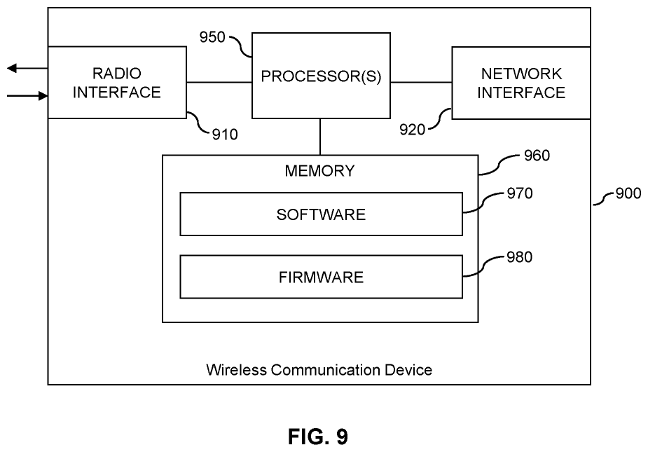

FIG. 9 illustrates a processor-based implementation of a wireless communication device 900. The structures as illustrated in FIG. 9 may be used for implementing the above-described concepts. The wireless communication device 900 may for example correspond to one of above-mentioned STAs 20 or to one of the above-mentioned APs 10.

As illustrated, the wireless communication device 900 includes a radio interface 910. The radio interface 910 may for example be based on a WLAN technology, e.g., according to an IEEE 802.11 family standard. However, other wireless technologies could be supported as well, e.g., the LTE technology or the NR technology. Further, the wireless communication device 900 may be provided with a network interface 920 for connecting to a data network, e.g., using a wire-based connection.

Further, the wireless communication device 900 may include one or more processors 950 coupled to the interfaces 910, 920, and a memory 960 coupled to the processor(s) 950. By way of example, the interfaces 910, 920, the processor(s) 950, and the memory 960 could be coupled by one or more internal bus systems of the wireless communication device 900. The memory 960 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 960 may include software 970 and/or firmware 980. The memory 960 may include suitably configured program code to be executed by the processor(s) 950 so as to implement the above-described functionalities for controlling wireless transmissions, such as explained in connection with the method of FIG. 7 or the method of FIG. 8.

It is to be understood that the structures as illustrated in FIG. 9 are merely schematic and that the wireless communication device 900 may actually include further components which, for the sake of clarity, have not been illustrated, e.g., further interfaces or further processors. Also, it is to be understood that the memory 960 may include further program code for implementing known functionalities of an AP or non-AP STA in an IEEE 802.11 standard compliant technology. According to some embodiments, also a computer program may be provided for implementing functionalities of the wireless communication device 900, e.g., in the form of a physical medium storing the program code and/or other data to be stored in the memory 960 or by making the program code available for download or by streaming.

As can be seen, the concepts as described above may be used for enabling efficient and accurate transmission parameter estimation in conditions with low SNR, e.g., in the above-mentioned LR mode. By providing the preamble extension in addition to the legacy preamble, coexistence with legacy devices can be achieved. Further, by providing the preamble extension in only some wireless transmissions, excessive overhead can be avoided.

It is to be understood that the examples and embodiments as explained above are merely illustrative and susceptible to various modifications. For example, the illustrated concepts may be applied in connection with various kinds of wireless technologies, without limitation to WLAN technologies. Further, the illustrated concepts may be applied with respect to various enhancements of existing technologies, which require parameter estimation at low SNR, without limitation to range extension modes. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-27. (canceled)

28. A method of controlling wireless transmissions in a wireless communication system, the method comprising:
a wireless communication device receiving at least one wireless transmission consisting of a preamble portion and a data portion, the preamble portion consisting of an initial part, which is supported by a set of wireless communication devices, and an extension part which is supported by only a subset of the set of wireless communication devices; and
in response to the wireless communication device belonging to the subset, the wireless communication device estimating at least one transmission parameter based on the extension part of the received wireless transmission, wherein the estimation of the at least one transmission parameter is based on cross-correlation of at least the extension part with a predefined signal sequence or on autocorrelation of at least the extension part with a delayed version of itself.

29. The method of claim 28, comprising:
in response to the wireless communication device belonging to the subset, the wireless communication device estimating the at least one transmission parameter based on the initial part and the extension part of the received wireless transmission.

30. The method of claim 28, comprising:
in response to the wireless communication device not belonging to the subset, the wireless communication device terminating reception processing of the wireless transmission upon detecting the extension part.

31. The method of claim 28, comprising:
the wireless communication device receiving a sequence of wireless transmissions comprising the at least one wireless transmission having the preamble portion with the extension part and at least one further wireless transmission having a preamble portion without the extension part.

32. The method of claim 31, wherein only the first wireless transmission of the received sequence has the preamble portion with the extension part.

33. The method of claim 31, wherein only every j-th wireless transmission of the received sequence has the preamble portion with the extension part, where j is an integer larger than 1.

34. The method of claim 31, comprising:
for the at least one wireless transmission having the preamble portion with the extension part, the wireless communication device performing the estimation of the at least one transmission parameter within a first estimation range; and
for the at least one further wireless transmission having the preamble portion without the extension part, the wireless communication device performing the estimation of the at least one transmission parameter within a second estimation range which is smaller than the first estimation range.

35. The method of claim 28, wherein the at least one transmission parameter comprises a frequency offset.

36. The method of claim 28, wherein the at least one transmission parameter comprises a reference time.

37. The method of claim 28, wherein the wireless communication system is based on a Wireless Local Area Network technology according to the IEEE 802.11 standards family.

38. A non-transitory computer-readable medium comprising, stored thereupon, program code to be executed by at least one processor of a wireless communication device, the program code being configured so that execution of the program code causes the wireless communication device to perform the method of claim 28.

39. A method of controlling wireless transmissions in a wireless communication system, the method comprising:
a wireless communication device sending at least one wireless transmission consisting of a preamble portion and a data portion, the preamble portion consisting of an initial part, which is supported by a set of wireless communication devices, and an extension part which is supported by only a subset of the set of wireless communication devices,
wherein the initial part enables estimation of at least one transmission parameter by the set of wireless communication devices and the extension part enables estimation of the at least one transmission parameter by the subset of the set of wireless communication devices, wherein the estimation of the at least one transmission parameter is based on cross-correlation of at least the extension part with a predefined signal sequence or on autocorrelation of at least the extension part with a delayed version of itself.

40. The method of claim 39, comprising:
the wireless communication device generating the extension part based on a repetition of at least a part of the initial part.

41. The method of claim 39, comprising:
the wireless communication device sending a sequence of wireless transmissions comprising the at least one wireless transmission having the preamble portion with the extension part and at least one further wireless transmission having a preamble portion without the extension part.

42. The method of claim 41, wherein only the first wireless transmission of the received sequence has the preamble portion with the extension part.

43. The method of claim 41, wherein only every j-th wireless transmission of the received sequence has the preamble portion with the extension part, where j is an integer larger than 1.

44. The method of claim 39, wherein the at least one transmission parameter comprises a frequency offset.

45. The method of claim 39, wherein the at least one transmission parameter comprises a reference time.

46. The method of claim 39, wherein the wireless communication system is based on a Wireless Local Area Network technology according to the IEEE 802.11 standards family.

47. A non-transitory computer-readable medium comprising, stored thereupon, program code to be executed by at least one processor of a wireless communication device, the program code being configured so that execution of the program code causes the wireless communication device to perform the method of claim 39.

48. A wireless communication device for a wireless communication system, the wireless communication device comprising processing circuitry and memory operatively coupled to the processing circuitry, the memory comprising program instructions for execution by the processing circuitry whereby the wireless communication device is configured to:
receive at least one wireless transmission consisting of a preamble portion and a data portion, the preamble portion consisting of an initial part, which is supported by a set of wireless communication devices, and an extension part which is supported by only a subset of the set of wireless communication devices; and
in response to the wireless communication device belonging to the subset supporting the extension part, estimate at least one transmission parameter based on the extension part of the received wireless transmission, wherein the estimation of the at least one transmission parameter is based on cross-correlation of at least the extension part with a predefined signal sequence or on autocorrelation of at least the extension part with a delayed version of itself.

49. A wireless communication device for a wireless communication system, the wireless communication device comprising processing circuitry and memory operatively coupled to the processing circuitry, the memory comprising program instructions for execution by the processing circuitry whereby the wireless communication device is configured to:
send at least one wireless transmission consisting of a preamble portion and a data portion, the preamble portion consisting of an initial part, which is supported by a set of wireless communication devices, and an extension part which is supported by only a subset of the set of wireless communication devices,
wherein the initial part enables estimation of at least one transmission parameter by the set of wireless communication devices and the extension part enables estimation of the at least one transmission parameter by the subset of the set of wireless communication devices, wherein the estimation of the at least one transmission parameter is based on cross-correlation of at least the extension part with a predefined signal sequence or on autocorrelation of at least the extension part with a delayed version of itself.
